(19) United States
(12) Patent Application Publication
(10) Pub. No.: US 2008/0062573 A1
(43) Pub. Date: Mar. 13, 2008

(54) Magnetic head

(75) Inventor: Masayuki Tatewaki, Kawasaki (JP)

Correspondence Address: Patrick G. Burns, Esq.;GREER, BURNS & CRAIN, LTD., 300S. WACKER DRIVE, 25TH FLOOR, Chicago, IL, 60606, US

(73) Assignee: Fujitsu Limited, Kawasaki-shi (JP)

(21) Appl. No.: 11/789,852

(22) Filed: Apr. 26, 2007

(30) Foreign Application Priority Data
Sep. 8, 2006 (JP) 2006-243865

(51) Int. Cl. G11B 5/127

(52) U.S. Cl. 360/313; 977/960

(57) ABSTRACT

An object of the present invention is to provide a magnetic head in which symmetry of a reproduction waveform output is increased and its spread is decreased without decreasing the reproduction output. The film thickness of the distal end of the hard bias layer providing a bias magnetic field to the free layer is 11 nm or more, or the distance between the distal end section of the hard bias layer and the free layer is 5 nm or more to 14 nm or less. Alternatively, the relationship between the saturation magnetization Ms_f of the free layer and saturation magnetization Ms_b of the hard bias layer satisfies the condition: Ms_f≦0.8*Ms_b.

### CROSS-REFERENCE TO RELATED APPLICATIONS

This application is based upon and claims the benefit of priority from the prior Japanese Patent Application No. 2006-243865, filed on Sep. 8, 2006, the entire contents of which are incorporated herein by reference.

### BACKGROUND OF THE INVENTION

1. Field of the Invention

The present invention relates to a magnetic head, and more particularly to a magnetic head in which asymmetry of a reproduction waveform and spread thereof are decreased without decreasing the reproduction output.

2. Description of the Related Art

A magnetic head of a hard bias system typically has the so-called tunnel magnetic resistance film, and tapered surfaces are formed at both end sections of the side surface of the resistance film, the ABS surface side (side of the surface facing the medium) serving as a front surface. Furthermore, a ferromagnetic layer is provided in contraposition to the tapered surfaces, and a pair of hard bias layers are configured by the ferromagnetic layer. The tunnel magnetic resistance film layer has a configuration sandwiched between a free layer (soft magnetic layer) formed on the upper layer surface thereof and a pin layer formed on the lower layer surface.

In the magnetic head of such configuration, the free layer operates according to the direction of the magnetic field determined by the recording medium surface, and the magnetic field (bias magnetic field) created by the hard bias layer stabilizes the magnetization state of the free layer and provides for good reproduction waveform characteristic (symmetrical) determined by the magnetic field of the recording medium.

Therefore, if the bias magnetic field from the hard bias layer is increased, the stability of the magnetization state of the free layer increases, the symmetry of the reproduction waveform from the free layer becomes better, and the spread of the reproduction waveform decreases.

However, if the bias magnetic field becomes too large, the component of magnetization in the direction of the bias magnetic field increases, the variation amount of the magnetization direction with respect to the signal magnetic field from the recording medium decreases, and the reproduction waveform output (reproduction signal sensitivity of the magnetic head) decreases.

On the other hand, a method for manufacturing a magnetic resistance reading device in which a joint section of a MR (magnetic resistance) layer and hard magnetic bias layers present on both sides thereof has a tapered shape has been disclosed as a conventional technology relating to magnetic heads (for example, Japanese Patent Application Laid-open No. 3-125311).

Furthermore, a thin-film magnetic head has also been disclosed in which a hard bias layer is formed from a Co—Cr—Ta magnetic film and a sufficient bias magnetic field is applied to the magnetic resistance layer, and also the lower base layer and upper base layer of the hard bias layer are Cr films and the adverse effect on magnetic characteristics of the hard bias layer is prevented (for example, Japanese Patent Application Laid-open No. 8-45035).

A magnetic resistance effect head in which a bias magnetic field application film is configured by laminating a Co-based hard magnetic layer and a magnetic lower base layer and a noise called Barkhausen noise is effectively removed has also been disclosed (for example, Japanese Patent Application Laid-open No. 10-312512).

### SUMMARY OF THE INVENTION

However, none of the above-described patent references described any measures against the increase in bias magnetic field. Therefore, in the configurations of the above-described patent references, the increase in bias magnetic field decreases the reproduction waveform output and increases the spread thereof.

Accordingly, the present invention was created to resolve the above-described problems and it is an object of the present invention to provide a magnetic head in which the symmetry of the reproduction waveform output is improved and spread thereof is reduced without decreasing the reproduction waveform output.

In order to attain the aforementioned object, the present invention in accordance with one mode thereof provides a magnetic head having a tunnel magnetic resistance film, a free layer, and a hard bias layer provided in contraposition to tapered surfaces formed on side surface sections at both ends of the tunnel magnetic resistance film and the free layer and providing a bias magnetic field to the free layer, wherein a film thickness of the distal end of the hard bias layer is 11 nm or more.

In this magnetic head, the film thickness of the distal end of the hard bias layer is a thickness of the hard bias layer along a track direction of a recording medium in a position of approximately 10 nm with respect to a cross point of the hard bias layer and a plane obtained by extending a central plane of the free layer.

Furthermore, in order to attain the aforementioned object, the present invention in accordance with another mode thereof provides a magnetic head having a tunnel magnetic resistance film, a free layer, and a hard bias layer provided in contraposition to tapered surfaces formed on side surface sections at both ends of the tunnel magnetic resistance film and the free layer and providing a bias magnetic field to the free layer, wherein the distance between a distal end section of the hard bias layer and the free layer is 5 nm or more to 14 nm or less.

In this magnetic head, the distance between the distal end section of the hard bias layer and the free layer is a distance between a contact point in which a plane obtained by extending a central plane of the free layer comes into contact with insulating layers disposed so as to sandwich the hard bias layer and a contact point in which the plane obtained by extending the central plane comes into contact with the hard bias layer.

Furthermore, in order to attain the aforementioned object, the present invention in accordance with yet another mode thereof provides a magnetic head having a tunnel magnetic resistance film, a free layer, and a hard bias layer provided in contraposition to tapered surfaces formed on side surface sections at both ends of the tunnel magnetic resistance film and the free layer and providing a bias magnetic field to the free layer, wherein the free layer and the hard bias layer are configured so that the following condition is satisfied: Ms_f≦0.8*Ms_b, where Ms_f stands for a saturation magnetization of the free layer and Ms_b stands for a saturation magnetization of the distal end of the hard bias layer.

In this magnetic head, the distal end of the hard bias layer is a hard bias layer having no lower base layer as an underlayer.

The present invention can provide a magnetic head in which the symmetry of a reproduction waveform output is increased and its spread is decreased without decreasing the reproduction output.

### BRIEF DESCRIPTION OF THE DRAWINGS

FIG. 1 shows a configuration example of a magnetic head;

FIG. 2 shows a configuration example of a magnetic head;

FIG. 3 shows a configuration example of a magnetic head;

FIG. 4 is a graph illustrating the simulation results;

FIG. 5 is a graph illustrating the simulation results;

FIG. 6 is a graph illustrating the simulation results;

FIG. 7 is a graph illustrating the simulation results;

FIG. 8 is a graph illustrating the simulation results; and

FIG. 9 is a graph illustrating the simulation results.

### DESCRIPTION OF THE PREFERRED EMBODIMENTS

The best mode for carrying out the present invention will be described below with reference to the appended drawings.

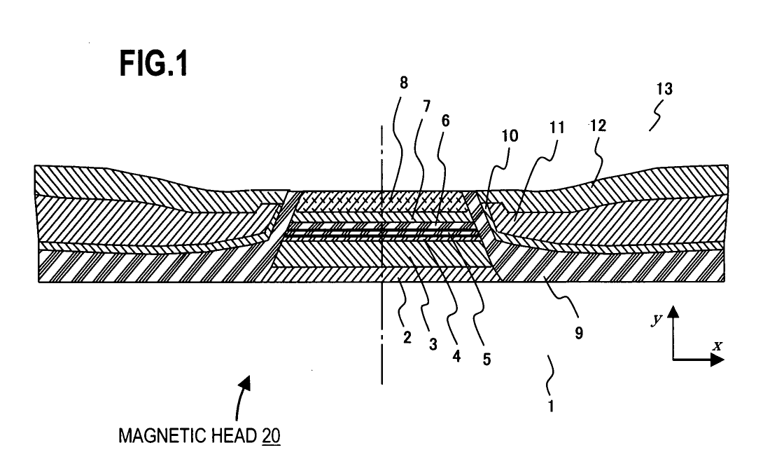

FIG. 1 shows a configuration example of a magnetic head 20 to which the present invention is applied. FIG. 1 is a view of the magnetic head 20 from the direction opposite that of the disk-shaped recording medium. In the figure, the “x” direction is a track direction of the recording medium and the “y” direction is an advance direction of the track.

As shown in FIG. 1, the magnetic head 20 comprises a lower shield 1, a lower base layer 2, an antiferromagnetic layer (AFM) 3, a pin layer 4, a tunnel magnetic resistance film 5, a free layer 6, and upper base layers 7, 8. Furthermore, the magnetic head 20 comprises an insulating layer 9, a lower base layer 10, a hard bias layer (ferromagnetic layer) 11, an insulating layer 12, and an upper shield 13.

The antiferromagnetic layer 3, pin layer 4, tunnel magnetic resistance film 5, and free layer 6 are laminated in the order of description in the “y” direction, and they are sandwiched between the lower base layer 2 and upper base layers 7, 8. The so-called magnetic resistance layer is formed within the space from the lower base layer 2 to the upper base layer 8.

Among those layers, because the free layer 6 has a property of being sensitive and reacting to an external magnetic field and operates according to the orientation of magnetic field recorded on the disk medium surface, the free layer serves as a sensor.

The antiferromagnetic layer 3 has an orientation of magnetic field in the mutually opposite directions and stabilizes the magnetic field of the free layer 6, etc. Furthermore, the upper and lower shields 1, 13 serve as shields for protecting from the external magnetic field.

On the other hand, the hard bias layer 11 is sandwiched between two insulating layers 9, 12, and has a lower base layer 10 disposed on the lower side thereof (side in the “−y” direction). Furthermore, the hard bias layer 11 is provided in contraposition to taper surfaces formed on side surface sections at both ends of the tunnel magnetic resistance film 5 and free layer 6.

The hard bias layer 11 makes it possible to obtain a stable reproduction output from the free layer 6 by aligning the magnetic field orientation in a certain constant direction with respect to the free layer (for example, “−x” direction).

Thus, in certain positions on the disk medium, the free layer 6 is rapidly rotated by the signal magnetic field thereof and the output characteristic of the reproduction output sometimes becomes nonlinear. Accordingly, by applying a bias magnetic field from the hard bias layer 11 to the free layer 6, the reproduction output is made linear and caused to trace the magnetic field recorded on the medium.

As described above, if the bias magnetic field is increased, the magnetization state of the free layer 6 is stabilized and the symmetry of the reproduction output waveform is improved. However, the bias magnetic field component in free layer 6 increases, the variation of magnetization direction with respect to the signal magnetic field decreases, and the reproduction waveform output decreases.

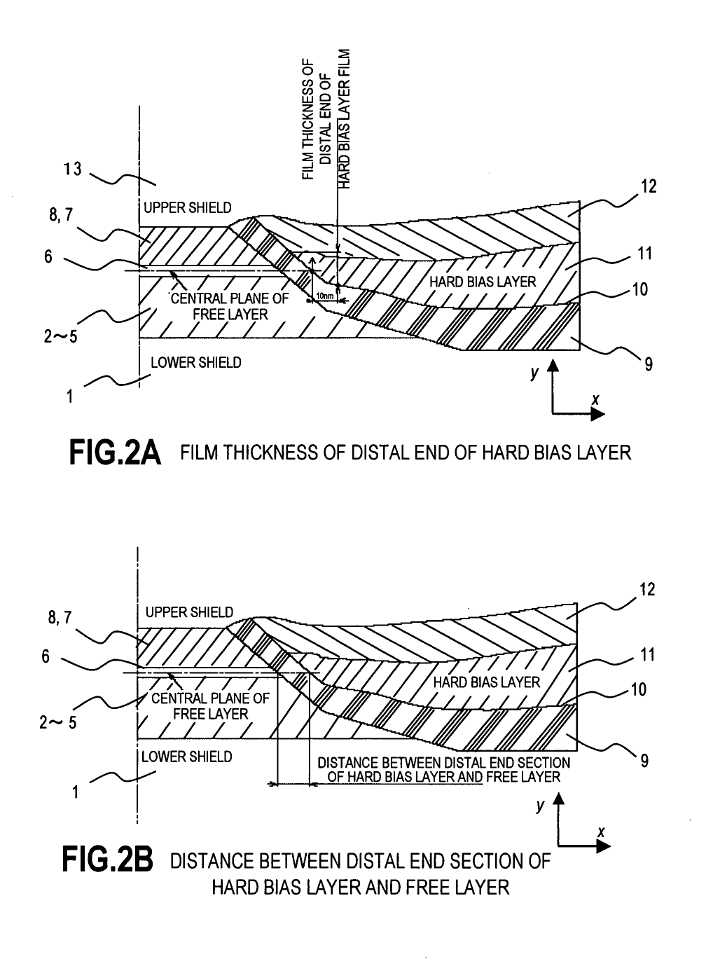

FIG. 2A shows a configuration example of the magnetic head 20 in which such trade-off effect is reduced and the symmetry is increased and spread thereof is decreased without decreasing the output. The main portion of the magnetic head of FIG. 1 is shown herein on a large scale.

Thus, in this example, the film thickness of the distal end of the hard bias layer 11 is made equal to or larger than “11 nm”. As shown in FIG. 2A, in this example, the film thickness of the hard bias layer 11 in the track advance direction (“y” direction) of the recording medium is made “11 nm” or more at a distance of approximately “10 nm” in the track direction (“x” direction) of the recording medium with respect to a cross point of the hard bias layer 11 and a plane obtained by extending the central plane of the free layer 6.

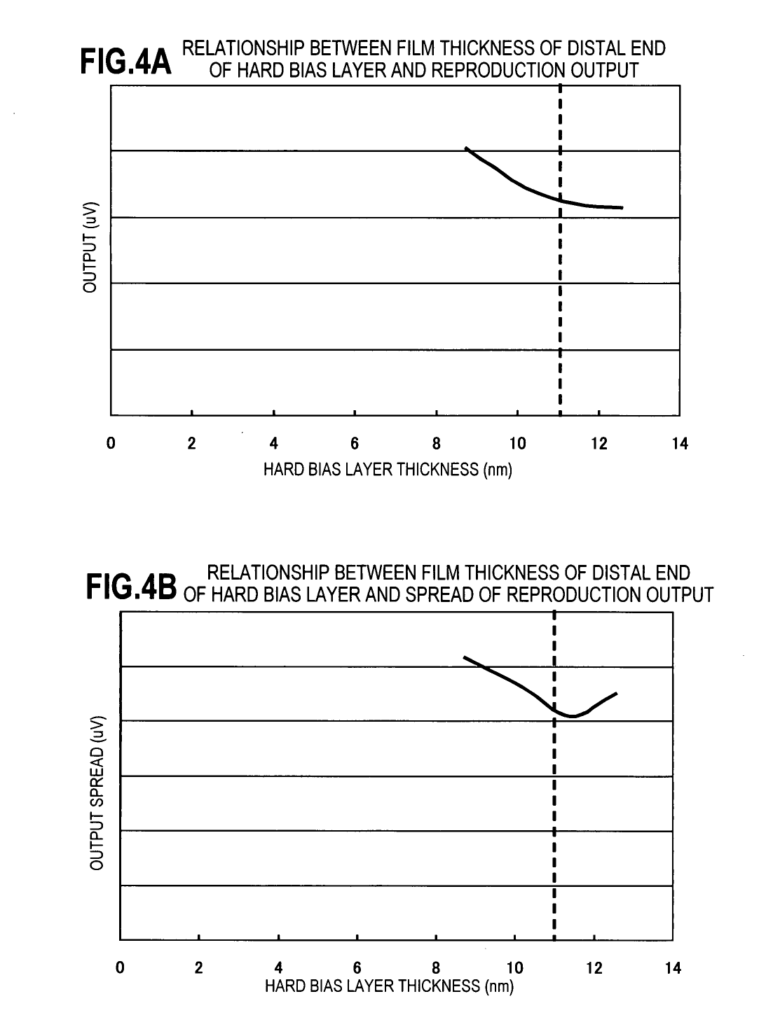

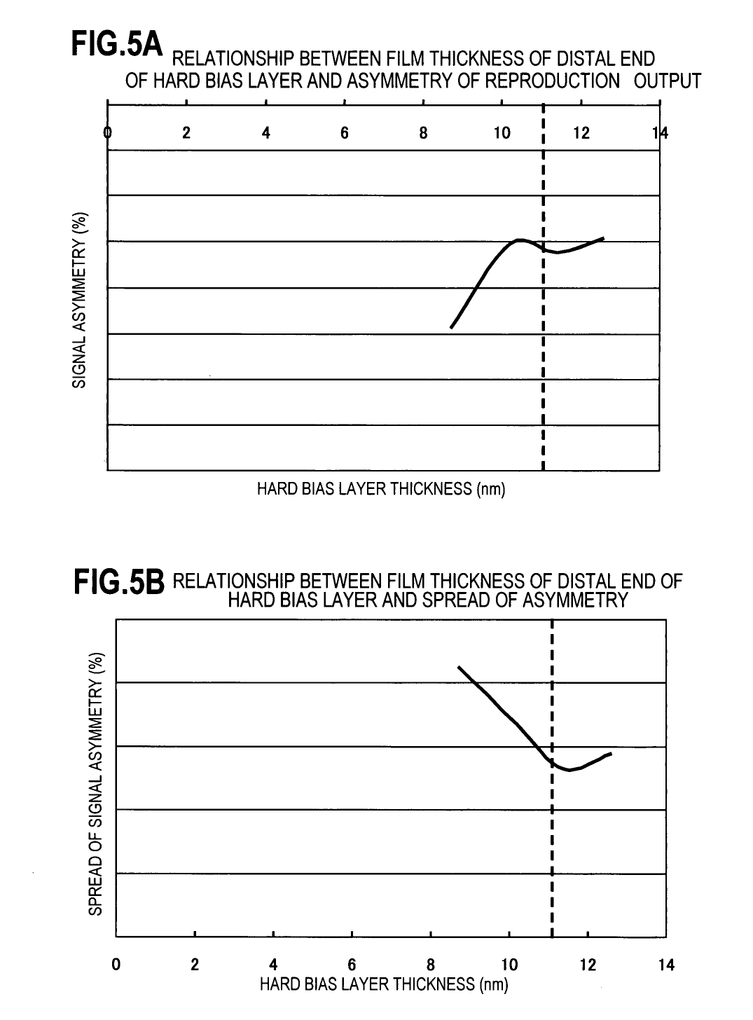

The inventors have conducted simulation of the magnetic head 20 of such configuration. FIG. 4 and FIG. 5 are the graphs showing the results obtained.

FIG. 4A is a graph showing the relationship between the film thickness of the distal end of the hard bias layer 11 (abscissa: “hard bias layer thickness”) and reproduction output (ordinate: “output”). A sinusoidal single-period magnetic field is applied between the lower base layer 2 and upper base layer 8, and the reproduction output (voltage) is the output generated between the lower base layer 2 and upper based layer 8 at this time. All the below-described graphs describe the effect obtained when the external magnetic field is applied.

As shown in FIG. 4A, if the film thickness of the distal end of the hard bias layer 11 is gradually increased, the reproduction output thereof is gradually decreased. However, a result was obtained indicating that when the film thickness is “11 nm” or more, the reproduction output is practically not decreased.

FIG. 4B is a graph showing the film thickness of the distal end of the hard bias layer 11 and the spread of the reproduction output thereof (ordinate: “output spread”, spread or standard deviation with respect to the average reproduction output). The spread of the reproduction output was decreased at most at a film thickness of approximately “11 nm”.

FIG. 5A illustrates the relationship between the film thickness of the distal end of the hard bias layer 11 and the asymmetry of the reproduction output (ordinate: “signal asymmetry”, serves as an index of reproduction output asymmetry, the closer it to “0”, the better is the symmetry). The symmetry of the reproduction output improves at a film thickness of approximately “11 nm”.

Furthermore, FIG. 5B illustrates the relationship between the film thickness of the distal end of the hard bias layer 11 and the spread of asymmetry (ordinate: “spread of signal asymmetry”, the spread or standard deviation with respect to the average “signal asymmetry”). The highest symmetry of reproduction output, that is, the lowest spread of reproduction signal quality, is attained at a film thickness of approximately “11 nm”.

As described herein above, by setting the film thickness of the distal end of the hard bias layer 11 to “11 nm” or more, as shown in FIG. 2A, the decrease in the reproduction output can be inhibited (FIG. 4A), the symmetry of the reproduction output waveform can be increased (FIG. 5A), and the spread thereof can be reduced (FIG. 5B).

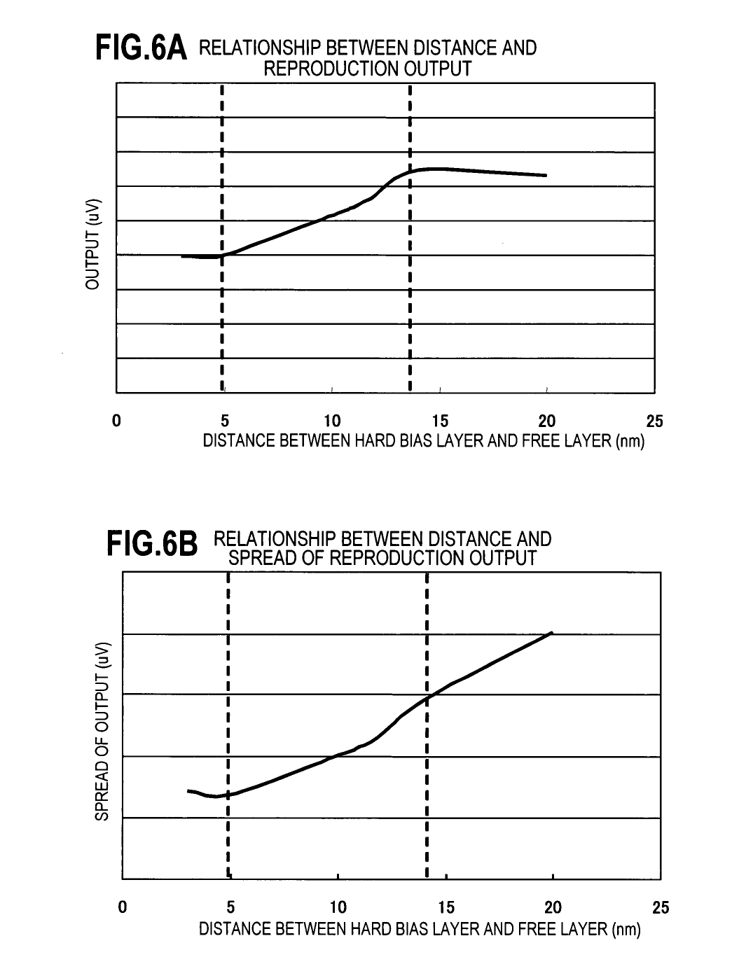

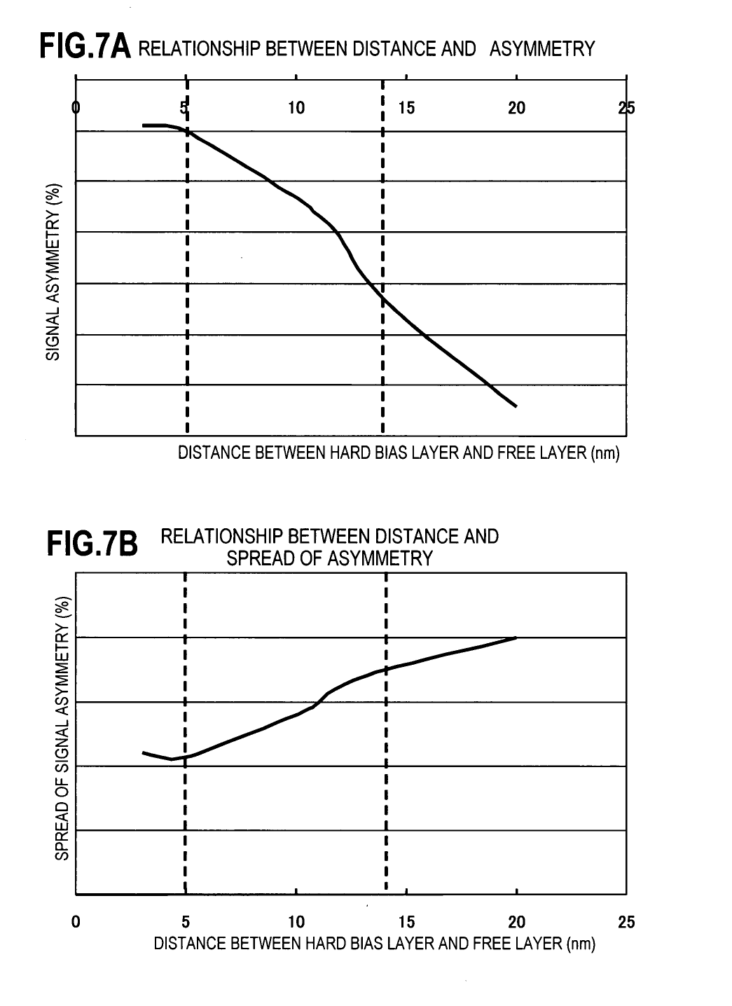

FIG. 2B shows another configuration example of the magnetic head 20 in which the symmetry is increased and the spread thereof is reduced without decreasing the output. The simulation results of such magnetic head are shown in FIG. 6 and FIG. 7.

In the example shown in FIG. 2B, the distance between the distal end of the hard bias layer 11 and the free layer is approximately “5 nm” or more to approximately “14 nm” or less. Thus, in this example, the distance from the contact point of the central plane of the free layer 6 and the insulating layer 9 to the contact point of the plane obtained by extending the central plane and the hard bias layer 11 is set to approximately “5 nm” or more to approximately “14 nm” or less.

FIG. 6A is a graph showing the relationship between the distance (abscissa: “distance between the hard bias layer and free layer”) and reproduction output, FIG. 6B is a graph showing the relationship between the distance and the spread of reproduction output, FIG. 7A is a graph showing the relationship between the distance and the asymmetry of reproduction waveform, and FIG. 7B is a graph showing the relationship between the distance and the spread of asymmetry.

As shown in FIG. 6A, when the distance is approximately “14 nm” or less, the reproduction output increases with the increase in the distance, but if the distance exceeds “14 nm”, the reproduction output assumes an almost constant value, regardless of the distance. On the other hand, in the relationship between the distance and the spread of reproduction output and between the distance and the spread of reproduction waveform asymmetry, as shown in FIG. 6B and FIG. 7B, the spread increases with the increase in distance even when the distance exceeds “14 nm”. Therefore, from the standpoint of decreasing the spread, without decreasing the output, it is preferred that the distance be “14 nm” or less. However, if the distance becomes too small, the insulating layer becomes too thin, thereby raising functional problems. FIGS. 6A and B and FIGS. 7A and B indicate that when the distance is “5 nm” or less, each characteristic value becomes almost constant and does not change. Therefore, with consideration for an excess decrease in the thickness of the insulating layer between the free layer 6 and hard bias layer 11, the distance is preferably “5 nm” or more.

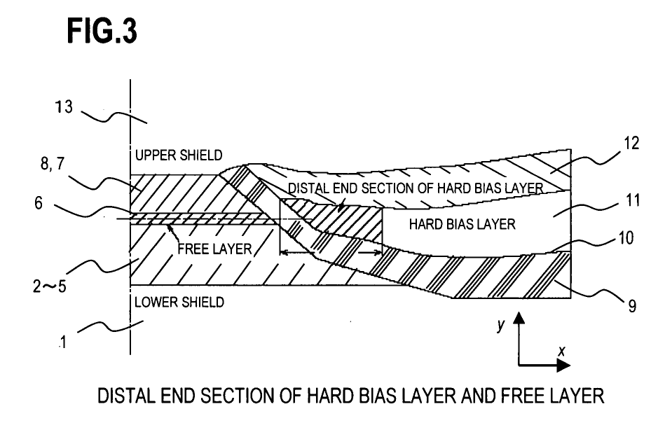

FIG. 3 similarly shows yet another configuration example of magnetic head 20. In this magnetic head 20, the following relationship is satisfied between the saturation magnetization Ms_b of the free layer 6 (the value attained when the magnetization became constant and saturated) and the saturation magnetization Ms_f of the distal end of the hard bias layer 11:

Ms_{—}f≦0.8*Ms_{—}b (1)

Configuring the magnetic head 20 so as to satisfy such relationship makes it possible to inhibit the decrease in reproduction output in the same manner as in the above-described example.

The lower base layer 10 is present in the underlayer of the hard bias layer 11, but this lower base layer 10 is not present in the distal end section that is a portion in direct contact with the insulating layer 9 (FIG. 1, FIG. 3). The distal end section of the hard bias layer 11 shown in FIG. 3 is a portion of the hard bias alloy 11 where no lower base layer 10 is present in the underlayer.

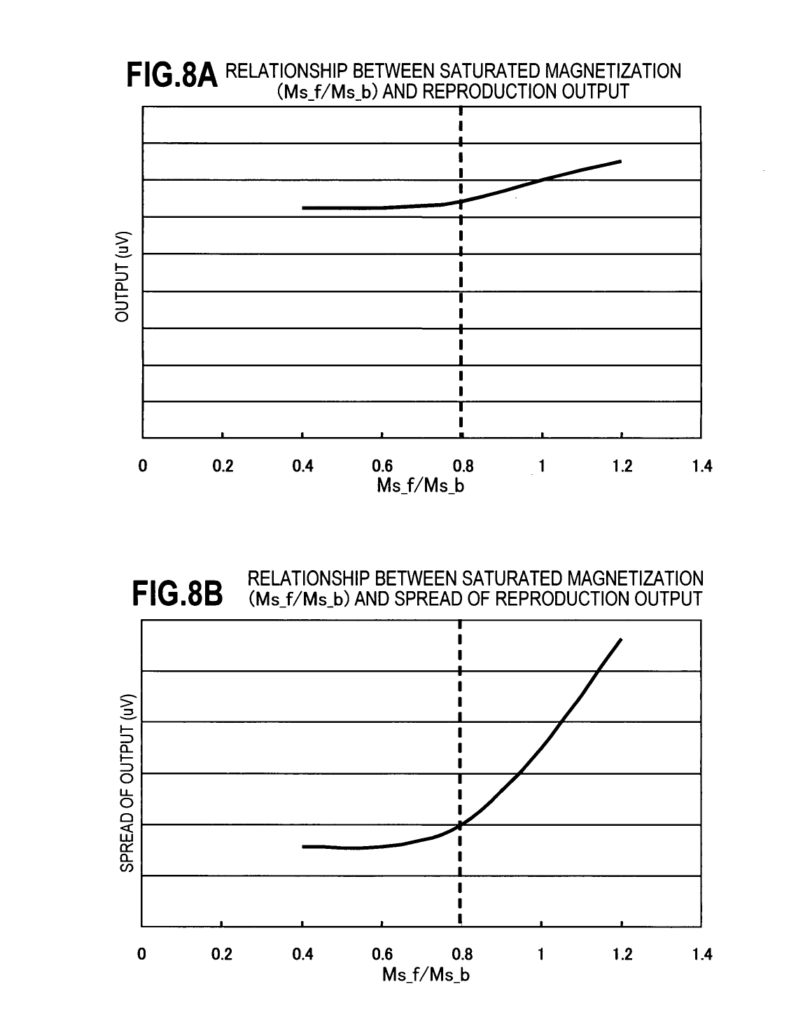

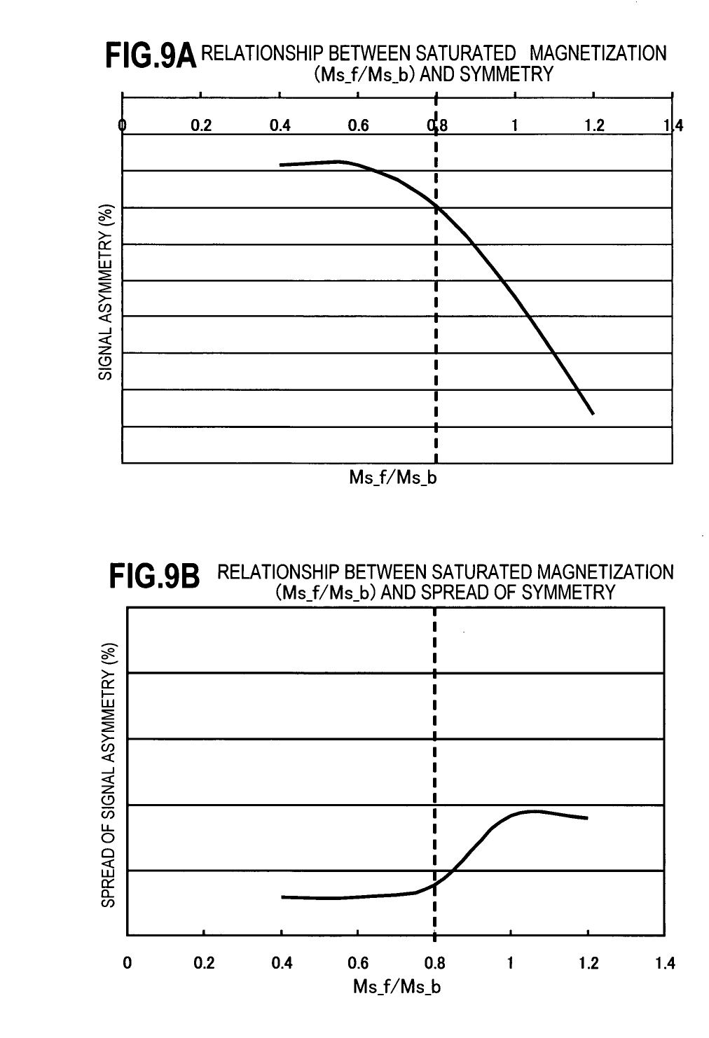

FIG. 8 and FIG. 9 are graphs showing the simulation results obtained in this case. Similarly to the above-described example, FIG. 8A is a graph showing the relationship between the saturated magnetization (abscissa: Ms_f/Ms_b) and the reproduction output, FIG. 8B is a graph showing the relationship between the saturated magnetization and the spread of reproduction output, FIG. 9A is a graph showing the relationship between the saturated magnetization and the asymmetry of reproduction waveform, and FIG. 9B is a graph showing the relationship between the saturated magnetization and the spread of asymmetry.

As shown in FIG. 8A, even when “Ms_f/Ms_b” is “0.8” or more, no significant change in the reproduction output is observed with respect to the results obtained at “0.8” or less. However, as shown in FIG. 8B, the spread of the reproduction output is small at “0.8” or less.

Furthermore, as shown in FIG. 9A, the symmetry of the reproduction waveform is good at “0.8” or less, and the waveform rapidly becomes asymmetric at larger values. As shown in FIG. 9B, the spread of symmetry is small at “0.8” or less and increases at larger values.

As described hereinabove, by configuring the magnetic head 20 so as to satisfy the relationship represented by Formula (1), the decrease in the reproduction output can be inhibited (FIG. 8A), the symmetry of the reproduction waveform can be increased (FIG. 9A), and the spread thereof can be reduced (FIG. 9B).

In all the above-descried examples, the magnetic head 20 illustrates the advantageous application of the present invention to magnetic heads for hard disks, but the operation effect identical to that of the above-described examples is also demonstrated with magnetic heads for other magnetic recording media.

What is claimed is:

1. A magnetic head comprising:
a tunnel magnetic resistance film;
a free layer; and
a hard bias layer provided in contraposition to taper surfaces formed on side surface sections at both ends of said tunnel magnetic resistance film and said free layer and providing a bias magnetic field to said free layer, wherein
a film thickness of the distal end of said hard bias layer is 11 nm or more.

2. The magnetic head according to claim 1, wherein said film thickness of the distal end of the hard bias layer is a thickness of said hard bias layer along a track direction of a recording medium in a position of approximately 10 nm with respect to a cross point of said hard bias layer and a plane obtained by extending a central plane of said free layer.

3. A magnetic head comprising:
a tunnel magnetic resistance film;
a free layer; and
a hard bias layer provided in contraposition to taper surfaces formed on side surface sections at both ends of said tunnel magnetic resistance film and said free layer and providing a bias magnetic field to said free layer, wherein
a distance between a distal end section of said hard bias layer and said free layer is 5 nm or more to 14 nm or less.

4. The magnetic head according to claim 3, wherein the distance between the distal end section of said hard bias layer and said free layer is a distance between a contact point in which a plane obtained by extending a central plane of said free layer comes into contact with insulating layers disposed so as to sandwich said hard bias layer and a contact point in which said plane obtained by extending the central plane comes into contact with said hard bias layer.

5. A magnetic head comprising:
a tunnel magnetic resistance film;
a free layer; and
a hard bias layer provided in contraposition to taper surfaces formed on side surface sections at both ends of said tunnel magnetic resistance film and said free layer and providing a bias magnetic field to said free layer, wherein
said free layer and said hard bias layer are configured so that the following condition is satisfied: Ms_f≦0.8*Ms_b, where Ms_f stands for a saturation magnetization of said free layer and Ms_b stands for a saturation magnetization of the distal end of said hard bias layer.

6. The magnetic head according to claim 5, wherein the distal end of said hard bias layer is a hard bias layer having no lower base layer as an underlayer.
